(19) United States
(12) Patent Application Publication
(10) Pub. No.: US 2026/0186218 A1
(43) Pub. Date: Jul. 2, 2026

(54) Methods for Integrating Discrete Optical Components to Couple Light into Optical Fibers

(71) Applicant: Ayar Labs, Inc., San Jose, CA (US)

(72) Inventors: Chen Li, Santa Clara, CA (US); Chong Zhang, San Jose, CA (US); Li-Fan Yang, Santa Clara, CA (US); Matthew Sysak, Sunnyvale, CA (US)

(21) Appl. No.: 19/433,373

(22) Filed: Dec. 26, 2025

Related U.S. Application Data
(60) Provisional application No. 63/740,940, filed on Dec. 31, 2024.

(51) Int. Cl. G02B 6/42

(52) U.S. Cl. CPC G02B 6/4244; G02B 6/4239

(57) ABSTRACT

An optical module includes a mechanical platform with an optical component disposed on the mechanical platform. At least one mechanical block is disposed next to both the mechanical platform and the optical component. An adhesive is disposed between the at least one mechanical block and each of the mechanical platform and the optical component so as to adhere the at least one mechanical block to each of the mechanical platform and the optical component. In some embodiments, the adhesive is not disposed between the optical component and the mechanical platform. In some embodiments, the optical component is optically aligned with at least one other optical component on the mechanical platform before the at least one mechanical block is adhered to the optical component.

### CROSS-REFERENCE TO RELATED APPLICATIONS

This application claims priority under 35 U.S.C. 119(e) to U.S. Provisional Patent Application No. 63/740,940, filed on Dec. 31, 2024, the disclosure of which is incorporated herein by reference in its entirety for all purposes.

### BACKGROUND OF THE INVENTION

### 1. Field of the Invention

The present invention relates to optical data communication.

### 2. Description of the Related Art

Optical data communication systems operate by modulating laser light to encode digital data patterns. The modulated laser light is transmitted through an optical data network from a sending node to a receiving node. The modulated laser light having arrived at the receiving node is de-modulated to obtain the original digital data patterns. Implementation and operation of the optical data communication systems is dependent upon the transfer of light signals between different photonic devices. It is within this context that the present disclosed embodiments arise.

### SUMMARY OF THE INVENTION

In an example embodiment, an optical module is disclosed. The optical module includes a mechanical platform. The optical module also includes an optical component disposed on the mechanical platform. The optical module also includes at least one mechanical block disposed next to both the mechanical platform and the optical component. The optical module also includes an adhesive disposed between the at least one mechanical block and each of the mechanical platform and the optical component so as to adhere the at least one mechanical block to each of the mechanical platform and the optical component.

In an example embodiment, a method is disclosed for assembling an optical module. The method includes disposing an optical component on a mechanical platform. The method also includes disposing a mechanical block next to both the mechanical platform and the optical component. The method also includes disposing an adhesive between the mechanical block and each of the mechanical platform and the optical component so as to adhere the mechanical block to each of the mechanical platform and the optical component.

### BRIEF DESCRIPTION OF THE DRAWINGS

FIG. 1 shows a diagram of a top view of an optical module, in accordance with some embodiments.

FIG. 2 shows a diagram of a top view of an optical module, in accordance with some embodiments.

FIG. 3 shows a diagram of a top view of an optical module, in accordance with some embodiments.

FIG. 4A shows an isolated top view of the intermediate optics, with placement of the first set of mechanical blocks on a light input side of the array of lenses of the intermediate optics, in accordance with some embodiments.

FIG. 4B shows a front view of the intermediate optics, referenced as View A-A in FIG. 4A, in accordance with some embodiments.

FIG. 4C shows a side view of the intermediate optics, referenced as View B-B in FIG. 4A, in accordance with some embodiments.

FIG. 4D shows a side view of the intermediate optics, referenced as View C-C in FIG. 4A, in accordance with some embodiments.

FIG. 5A shows an isolated top view of the intermediate optics, with placement of the first set of mechanical blocks on the ends, respectively, of the array of lenses of the intermediate optics, in accordance with some embodiments.

FIG. 5B shows a front view of the intermediate optics, referenced as View A-A in FIG. 5A, in accordance with some embodiments.

FIG. 5C shows a side view of the intermediate optics, referenced as View B-B in FIG. 5A, in accordance with some embodiments.

FIG. 5D shows a side view of the intermediate optics, referenced as View C-C in FIG. 5A, in accordance with some embodiments.

FIG. 6A shows an isolated top view of the receiving optics, with placement of the second set of mechanical blocks on a light input side of the array of optical fibers of the receiving optics, in accordance with some embodiments.

FIG. 6B shows a front view of the receiving optics, referenced as View A-A in FIG. 6A, in accordance with some embodiments.

FIG. 6C shows a side view of the receiving optics, referenced as View B-B in FIG. 6A, in accordance with some embodiments.

FIG. 6D shows a side view of the receiving optics, referenced as View C-C in FIG. 6A, in accordance with some embodiments.

FIG. 7A shows an isolated top view of the receiving optics, with placement of the second set of mechanical blocks on the ends, respectively, of the array of optical fibers of the receiving optics, in accordance with some embodiments.

FIG. 7B shows a front view of the receiving optics, referenced as View A-A in FIG. 7A, in accordance with some embodiments.

FIG. 7C shows a side view of the receiving optics, referenced as View B-B in FIG. 7A, in accordance with some embodiments.

FIG. 7D shows a side view of the receiving optics, referenced as View C-C in FIG. 7A, in accordance with some embodiments.

FIG. 8A shows an example in which the mechanical blocks are configured as rectangular-shaped blocks, such as depicted in the examples of FIGS. 4A-4D, 5A-5D, 6A-6D, and 7A-7D, in accordance with some embodiments.

FIG. 8B shows an example in which the mechanical blocks are configured as rectangular-shaped blocks that have a concave fillet formed along an edge of the mechanical blocks that is positioned farthest away from both the optical component and the mechanical platform, in accordance with some embodiments.

FIG. 8C shows an example in which the mechanical blocks are configured as L-shaped blocks, in accordance with some embodiments.

FIG. 8D shows an example in which the mechanical blocks are configured as rectangular-shaped blocks that have a convex fillet formed along an edge of the mechanical blocks that is positioned farthest away from both the optical component and the mechanical platform, in accordance with some embodiments.

FIG. 8E shows an example in which the mechanical blocks are configured as rectangular-shaped blocks that have a chamfer formed along an edge of the mechanical blocks that is positioned farthest away from both the optical component and the mechanical platform, in accordance with some embodiments.

FIG. 8F shows an example in which the mechanical blocks are configured as triangular-shaped blocks that have a bevel formed along an edge of the mechanical blocks that is positioned farthest away from both the optical component and the mechanical platform, in accordance with some embodiments.

FIG. 9 shows a flowchart of a method for assembling an optical module, in accordance with some embodiments.

FIG. 10 shows a flowchart of a method for assembling an optical module, in accordance with some embodiments.

### DETAILED DESCRIPTION

In the following description, numerous specific details are set forth in order to provide an understanding of the embodiments disclosed herein. It will be apparent, however, to one skilled in the art that the embodiments disclosed herein may be practiced without some or all of these specific details. In other instances, well known process operations have not been described in detail in order not to unnecessarily obscure the disclosed embodiments.

Optical data communication systems operate by modulating laser light to encode digital data patterns within optical signals. In some embodiments, a ring modulator is used to modulate continuous wave laser light to generate the modulated laser light that conveys the encoding of digital data patterns. In some embodiments, the ring modulator is positioned within an evanescent optically coupling distance from a bus optical waveguide and operates to modulate light that is propagating through the bus optical waveguide. The ring modulator and associated optical waveguides are fabricated within an electro-optic chip and/or photonic integrated chip. The modulated laser light is transmitted through an optical data network from a sending node to a receiving node. The modulated laser light having arrived at the receiving node is de-modulated to obtain the original digital data patterns from the optical signals. The transmission of light through the optical data network includes transmission of light through optical fibers and transmission of light between optical fibers and photonic integrated circuits within electro-optic and/or photonic integrated chips. In some embodiments, implementation and operation of optical data communication systems is dependent upon having reliable and efficient techniques for connection of optical components in high-precision optical alignment configurations on substrate structures.

In some embodiments, photonic components that require high-precision optical alignment are affixed to a common substrate using adhesive that is curable by exposure to ultraviolet (UV) light. In some embodiments, the UV-curable adhesive is UV snap-cured to preserve the optical alignment position of the photonic components. However, the UV-curable adhesive is usually subject to shape and/or volume change due to various factors, such as mechanical stress relaxation of the adhesive, moisture absorption that leads to hygroscopic swelling of the adhesive, micro-delamination at the adhesive-to-substrate interface caused by thermal cycling and fatiguing, among other factors. The shape and/or volume change of the adhesive then translates into spatial displacement of the photonic components away from the optimal alignment position of the photonic components, leading to misalignment and lowered optical coupling efficiency between the photonic components.

Various embodiments are disclosed herein for using mechanical blocks to affix photonic components that require high-precision optical alignment with each other to a fixed reference frame, e.g., substrate, using epoxies or other adhesive materials. The use of mechanical blocks to secure photonic components to a common reference frame in a fixed spatial relationship to each other facilitates minimization of optical coupling loss due to optical alignment shift that is caused by adhesive shape and/or volume changes that occur with exposure to temperature and/or humidity variations, and/or because of the UV curing process. For example, in some embodiments, mechanical blocks are used to minimize the volume and/or bondline thickness of the adhesive and control the adhesive shift direction due to temperature and/or humidity variations and/or UV-curing induced variations, so as to minimize the adverse impact on optical coupling efficiency between the photonic components due to the temperature and/or humidity variations and/or UV-curing induced variations.

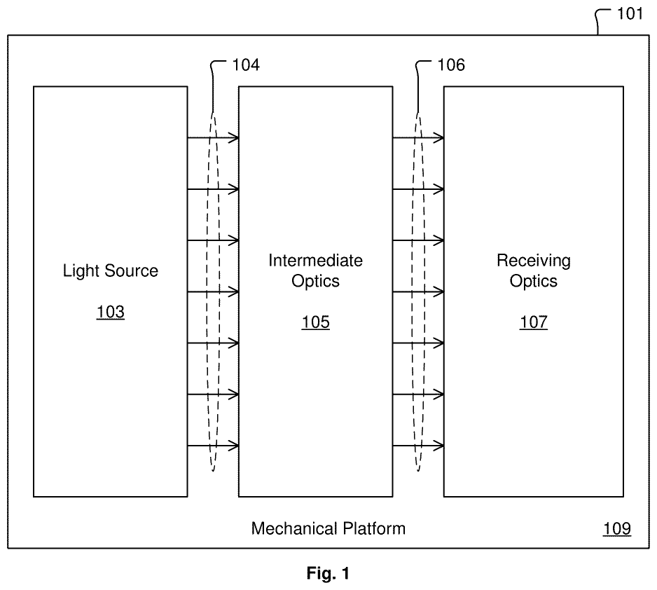

FIG. 1 shows a diagram of a top view of an optical module 101, in accordance with some embodiments. The optical module 101 includes a light source 103, intermediate optics 105 that shape and guide the light from the light source 103, and receiving optics 107 that receive the light from the light source 103 by way of the intermediate optics 105. In some embodiments, the receiving optics 107 are optically connected to photonics components/systems outside of the optical module 101. The optical module 101 also includes a mechanical platform 109. The light source 103, intermediate optics 105, and receiving optics 107 are mounted on the mechanical platform 109, such that the mechanical platform 109 provides a fixed reference frame for maintaining a fixed spatial relationship between the light source 103, the intermediate optics 105, and the receiving optics 107. In some embodiments, the mechanical platform 109 is a shared substrate for the light source 103, intermediate optics 105, and receiving optics 107.

In various embodiments, the light source 103 is a laser or a laser array that generates and outputs continuous wave laser light of a single wavelength (single channel) or of multiple wavelengths (multiple channels), as indicated by arrows 104, for use by other photonic components within the optical module 101 that include the receiving optics 107. In some embodiments, the intermediate optics 105 includes various optical components, such as lenses, mirrors, etc., as needed to shape and guide the light received from the light source 103 and convey the light to the receiving optics 107, as indicated by arrows 106. In various embodiments, the receiving optics 107 includes optical components that are configured to receive the light that is conveyed from the intermediate optics 105. In various embodiments, the receiving optics 107 includes one or more optical fiber(s), an optical fiber array, optical sensors, optical waveguides, and/or essentially any other optical component configured to accept light for optical conveyance and routing.

In order for the light that is output by the light source 103 to be efficiently coupled into receiving optics 107, it is necessary for high-precision optical alignment to be done between the light source 103, intermediate optics 105, and receiving optics 107. In some embodiments, this high-precision optical alignment includes careful adjustment of the relative positions and angles/orientations of each of the light source 103, the intermediate optics 105, and the receiving optics 107, in order to maximize the amount of light coupled into the receiving optics 107 from the light source 103, by way of the intermediate optics 105.

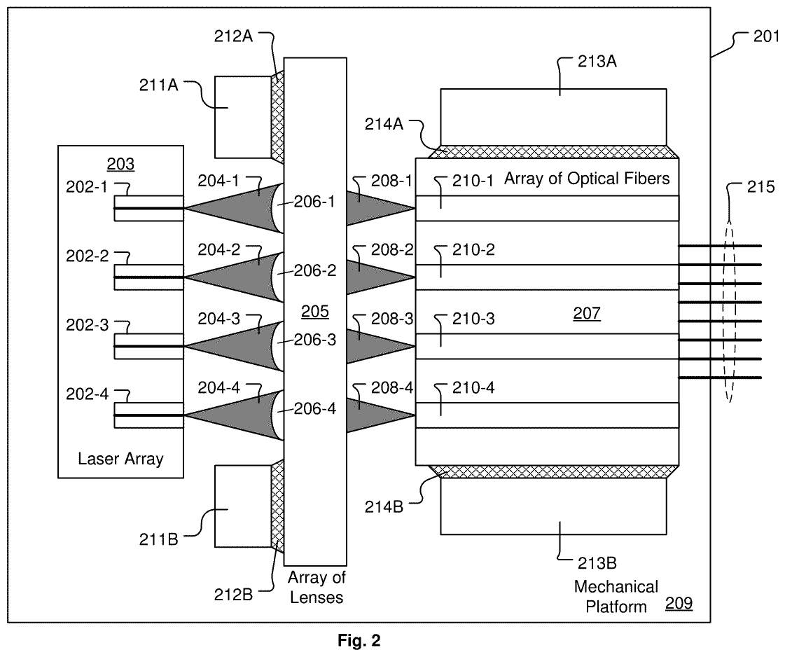

FIG. 2 shows a diagram of a top view of an optical module 201, in accordance with some embodiments. The optical module 201 includes a light source 203, intermediate optics 205, and receiving optics 207. In the example of FIG. 2, the light source 203 is array of lasers 202-1 to 202-4 configured to generate and output a plurality of laser beams 204-1 to 204-4 of continuous wave laser light. It should be understood that the light source 203 is shown by way of example. In other embodiments, the light source 203 includes either less than or more than four lasers. Also, in various other embodiments, the light source 203 can be defined as essentially any type of photonic device capable of outputting light signals that are either continuous wave light signals or modulated light signals.

In the example of FIG. 2, the intermediate optics 205 are configured as a lens array that includes multiple lenses 206-1 to 206-4 for the multiple laser beams 204-1 to 204-4, respectively, as output by the lasers 202-1 to 202-4, respectively, of the light source 203. Also, in the example of FIG. 2, the receiving optics 207 is configured as an optical fiber array that includes optical fibers 210-1 to 210-4 for receiving a plurality of light beams 208-1 to 208-4, respectively, by way of the array of lenses 206-1 to 206-4, respectively, of the intermediate optics 205. The light source 203, the intermediate optics 205, and the receiving optics 207 are attached to a mechanical platform 209. In some embodiments, the mechanical platform 209 is configured as a substrate. The continuous wave laser light beams 204-1 to 204-4 emitted by the light source 203 are focused by the array of lenses 206-1 to 206-4 of the intermediate optics 205 into the optical fibers 210-1 to 210-4 of the optical fiber array of the receiving optics 207. In some embodiments, an optical fiber pigtail 215 is optically connected to the optical fiber array of the receiving optics 207 to provide for conveyance of optical signals outside of the optical module 201.

In some embodiments, the light source 203, e.g., laser array, is physically attached to the mechanical platform 209, such as by soldering or by another attachment technique, prior to optical alignment of the intermediate optics 205 and receiving optics 207. Then, a high-precision optical alignment process is done to optically align the array of lenses 206-1 to 206-4 of the intermediate optics 205 and the optical fibers 210-1 to 210-4 of the receiving optics 207 to the light source 203, e.g., to the lasers 202-1 to 202-4, respectively. After completion of the high-precision optical alignment process between the light source 203, the intermediate optics 205, and the receiving optics 207, a first set of mechanical blocks 211A/211B are placed next to the intermediate optics 205. Also, a second set of mechanical blocks 213A/213B are placed next to the receiving optics 207. In some embodiments, an adhesive 212A is disposed between the mechanical block 211A and the intermediate optics 205, and between the mechanical block 211A and the mechanical platform 209. Also, an adhesive 212B is disposed between the mechanical block 211B and the intermediate optics 205, and between the mechanical block 211B and the mechanical platform 209. In some embodiments, an adhesive 214A is disposed between the mechanical block 213A and the receiving optics 207, and between the mechanical block 213A and the mechanical platform 209. Also, an adhesive 214B is disposed between the mechanical block 213B and the receiving optics 207, and between the mechanical block 213B and the mechanical platform 209.

In some embodiments, the adhesive 212A, 212B, 214A, 214B is a UV-curable adhesive that snap-cures upon exposure to UV light. In some embodiments, the UV-curable adhesive is initially non-sticky. Once disposed, the UV-curable adhesive is exposed to UV light of a prescribed wavelength and intensity for a prescribed amount of time to cause the UV-curable adhesive to transform and function as a glue that joins adjacent surfaces together. In this manner, the UV-curable adhesive 212A and 212B affixes the first set of mechanical blocks 211A and 211B, respectively, to both the intermediate optics 205 and the mechanical platform 209, with essentially no change in the high-precision optical alignment of the array of lenses 206-1 to 206-4 of the intermediate optics 205. Also, in this manner, the UV-curable adhesive 214A and 214B affixes the second set of mechanical blocks 213A and 213B, respectively, to both the receiving optics 207 and the mechanical platform 209, with essentially no change in the high-precision optical alignment of the optical fibers 210-1 to 210-4 of the receiving optics 207. The UV-curable adhesive 212A and 212B in combination with the first set of mechanical blocks 211A and 211B functions to hold the intermediate optics 205 in place on the mechanical platform 209. In some embodiments, there is essentially no adhesive disposed between the intermediate optics 205 and the mechanical platform 209, such that the first set of mechanical blocks 211A and 211B are the primary mechanisms for securing the intermediate optics 205 is a fixed spatial relationship with each of the mechanical platform 209, the light source 203, and the receiving optics 207. Also, the UV-curable adhesive 214A and 214B in combination with the second set of mechanical blocks 213A and 213B functions to hold the receiving optics 207 in place on the mechanical platform 209. In some embodiments, there is essentially no adhesive disposed between the receiving optics 207 and the mechanical platform 209, such that the second set of mechanical blocks 213A and 213B are the primary mechanisms for securing the receiving optics 207 is a fixed spatial relationship with each of the mechanical platform 209, the light source 203, and the intermediate optics 205.

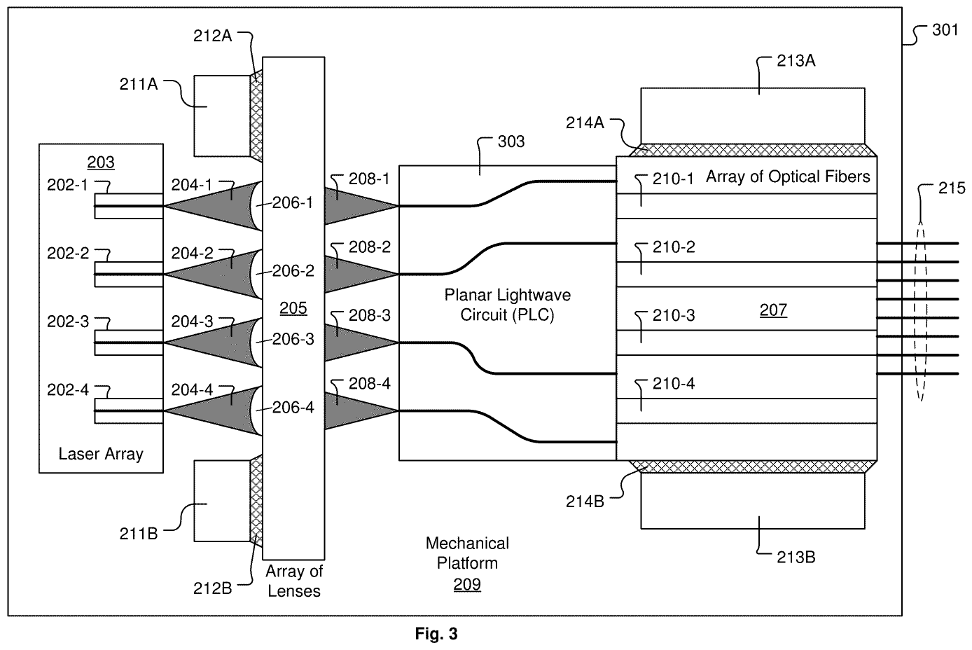

FIG. 3 shows a diagram of a top view of an optical module 301, in accordance with some embodiments. The optical module 301 is a variation of the optical module 201 described with regard to FIG. 2. The optical module 301 includes the light source 203 configured as the array of lasers 202-1 to 202-4, the intermediate optics 205 configured as the array of lenses 206-1 to 206-4, and the receiving optics 207 configured as the array of optical fibers 210-1 to 210-4. The optical module 301 also includes a planar lightwave circuit (PLC) 303 disposed between the intermediate optics 205 and the receiving optics 207. In various embodiments, the PLC 303 is configured to perform one or more optical processes, e.g., amplification, splitting, combining, multiplexing, modulation, and/or essentially any other optical process, on the light as it is conveyed through the PLC 303. In some embodiments, the PLC 303 includes a plurality of optical inputs for respectively receiving light from the plurality of laser beams 208-1 to 208-4 generated by the array of lasers 202-1 to 202-4 of the light source 203 and conveyed by way of the array of lenses 206-1 to 206-4 of the intermediate optics 205. Also, the PLC 303 includes a plurality of optical outputs for respectively conveying light into the plurality of optical fibers 210-1 to 210-4 of the optical fiber array of the receiving optics 207. In various embodiments, the PLC 303 is affixed to the mechanical platform 209 by an adhesive, a solder, or by another attachment technique. The PLC 303 is initially positioned in high-precision optical alignment with both the intermediate optics 205 and the receiving optics 207. The first set of mechanical blocks 211A and 211B and the second set of mechanical blocks 213A and 213B, in combination with the adhesives 212A, 212B, 214A, and 214B, collectively maintain the high-precision optical alignment configuration of the light source 203, the intermediate optics 205, the PLC 303, and the receiving optics 207, so as to provide for efficient and optimal conveyance of light from the array of lasers 202-1 to 202-4 of the light source 203 into the optical fibers 210-1 to 210-4 of the receiving optics 207.

In various applications, the adhesives 212A, 212B, 214A, 214B may change shape due to external environmental factors. For example, in some situations, a change in temperature and/or humidity (water) absorption by the adhesives 212A, 212B, 214A, 214B will cause a change in the physical shape of the adhesives 212A, 212B, 214A, 214B, which can lead to an adverse change of the initial high-precision optical alignment configuration between the light source 203, the intermediate optics 205, and the receiving optics 207, which can cause a reduction or interruption in conveyance of the light from the light source 203 to the receiving optics 207 by way of the intermediate optics 205 and, optionally, the PLC 303. Also, in some situations, the UV curing of the adhesives 212A, 212B, 214A, 214B will cause a change in the bond structure of the adhesives 212A, 212B, 214A, 214B, which can cause a change in the shape of the adhesives 212A, 212B, 214A, 214B, which can lead to an adverse change of the initial high-precision optical alignment configuration between the light source 203, the intermediate optics 205, and the receiving optics 207, which can cause a reduction or interruption in conveyance of the light from the light source 203 to the receiving optics 207 by way of the intermediate optics 205 and, optionally, the PLC 303. In some embodiments, the shape, size, and position of the mechanical blocks 211A/211B and 213A/213B are defined to minimize the adverse change of the initial high-precision optical alignment between the light source 203, the intermediate optics 205, and the receiving optics 207 that is caused by changes in the physical shape of the adhesives 212A, 212B, 214A, 214B over time due to variations in temperature and/or humidity, and/or because of the UV-curing of the adhesives 212A, 212B, 214A, 214B.

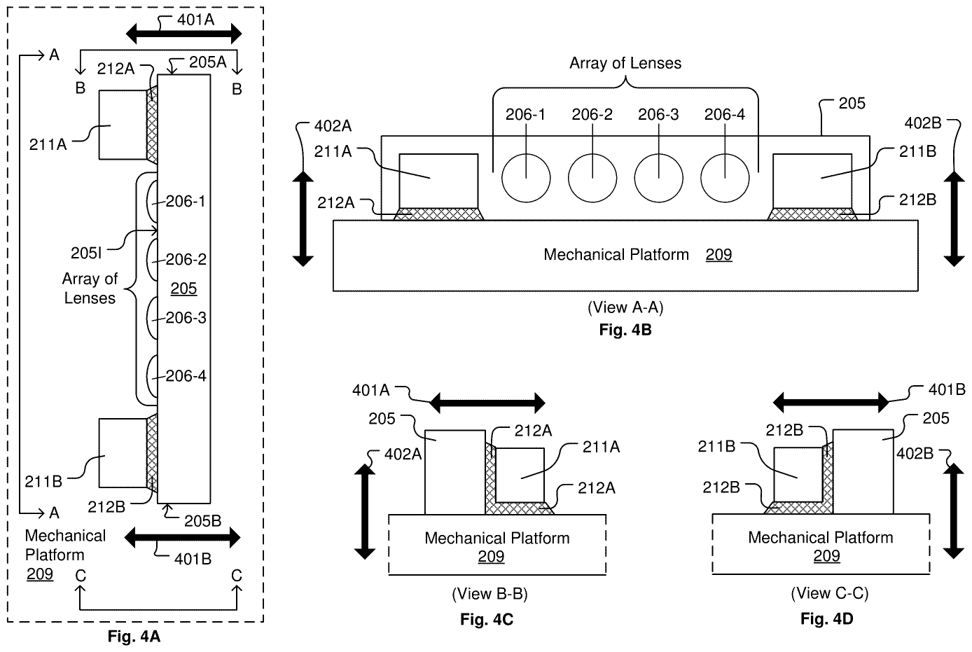

FIG. 4A shows an isolated top view of the intermediate optics 205, with placement of the first set of mechanical blocks 211A and 211B on a light input side 205I of the array of lenses 206-1 to 206-4 of the intermediate optics 205, in accordance with some embodiments. In this embodiment, shrinkage and/or expansion of the adhesives 212A and 212B disposed between the first set of mechanical blocks 211A and 211B, respectively, and the intermediate optics 205 causes movement of the array of lenses 206-1 to 206-4 of the intermediate optics 205 in a direction substantially parallel to the light propagation direction, as indicated by arrows 401A and 401B. In some embodiments, the bondline thickness of the adhesive 212A between the first mechanical block 211A and the intermediate optics 205 is substantially equal to the bondline thickness of the adhesive 212B between the second mechanical block 211B and the intermediate optics 205, such that the horizontal displacement of the first end 205A of the array of lenses 206-1 to 206-4 is substantially equal to the horizontal displacement of the second end 205B of the array of lenses 206-1 to 206-4 as the bondline thicknesses of the adhesives 212A and 212B change in size with changes in temperature and/or humidity and/or UV-curing. In some embodiments, the bondline thickness of the adhesive 212A between the mechanical block 211A and the intermediate optics 205 is larger than the bondline thickness of the adhesive 212B between the mechanical block 211B and the intermediate optics 205, so as to increase the corresponding horizontal movement of the first end 205A of the array of lenses 206-1 to 206-4 relative to the second end 205B of the array of lenses 206-1 to 206-4 in response to changes in size of the adhesives 212A and 212B with changes in temperature and/or humidity and/or UV-curing. Conversely, in some embodiments, the bondline thickness of the adhesive 212B between the mechanical block 211B and the intermediate optics 205 is larger than the bondline thickness of the adhesive 212A between the mechanical block 211A and the intermediate optics 205, so as to increase the corresponding horizontal movement of the second end 205B of the array of lenses 206-1 to 206-4 relative to the first end 205A of the array of lenses 206-1 to 206-4 in response to changes in size of the adhesives 212A and 212B with changes in temperature and/or humidity and/or UV-curing.

FIG. 4B shows a front view of the intermediate optics 205, referenced as View A-A in FIG. 4A, in accordance with some embodiments. FIG. 4B shows the adhesive 212A disposed between the mechanical block 211A and the mechanical platform 209. FIG. 4B also shows the adhesive 212B disposed between the mechanical block 211B and the mechanical platform 209. In some embodiments, the adhesives 212A and 212B expand in size with increased temperature and/or increased humidity primarily in the direction of the bondline thickness of the adhesives 212A and 212B. Also, the adhesives 212A and 212B contract with decreased temperature and/or decreased humidity primarily in the direction of the bondline thickness of the adhesives 212A and 212B. Also, in some embodiments, the adhesives 212A and 212B can change shape and/or size during the UV curing process as the bond structure of the adhesives 212A and 212B change. The expansion and contraction of the bondline thickness of the adhesives 212A and 212B causes a corresponding vertical movement of the array of lenses 206-1 to 206-4 of the intermediate optics 205 relative to the mechanical platform 209, as indicated by arrows 402A and 402B. In some embodiments, the bondline thickness of the adhesive 212A between the first mechanical block 211A and the mechanical platform 209 is substantially equal to the bondline thickness of the adhesive 212B between the second mechanical block 211B and the mechanical platform 209, such that the vertical displacement of the first end 205A of the array of lenses 206-1 to 206-4 is substantially equal to the vertical displacement of the second end 205B of the array of lenses 206-1 to 206-4 as the bondline thicknesses of the adhesives 212A and 212B change in size with changes in temperature and/or humidity and/or because of UV-curing. In some embodiments, the bondline thickness of the adhesive 212A between the mechanical block 211A and the mechanical platform 209 is larger than the bondline thickness of the adhesive 212B between the mechanical block 211B and the mechanical platform 209, so as to increase the corresponding vertical movement of the first end 205A of the array of lenses 206-1 to 206-4 relative to the second end 205B of the array of lenses 206-1 to 206-4 in response to changes in size of the adhesives 212A and 212B with changes in temperature and/or humidity and/or because of UV-curing. Conversely, in some embodiments, the bondline thickness of the adhesive 212B between the mechanical block 211B and the mechanical platform 209 is larger than the bondline thickness of the adhesive 212A between the mechanical block 211A and the mechanical platform 209, so as to increase the corresponding horizontal movement of the second end 205B of the array of lenses 206-1 to 206-4 relative to the first end 205A of the array of lenses 206-1 to 206-4 in response to changes in size of the adhesives 212A and 212B with changes in temperature and/or humidity and/or because of UV-curing.

FIG. 4C shows a side view of the intermediate optics 205, referenced as View B-B in FIG. 4A, in accordance with some embodiments. FIG. 4C shows the adhesive 212A disposed between the mechanical block 211A and each of the intermediate optics 205 and the mechanical platform 209. In some embodiments, the expansion and contraction of the bondline thickness of the adhesive 212A causes both the corresponding vertical movement of the array of lenses 206-1 to 206-4 of the intermediate optics 205 relative to the mechanical platform 209, as indicated by arrow 402A, and the corresponding horizontal movement of the array of lenses 206-1 to 206-4 of the intermediate optics 205 relative to the mechanical platform 209, as indicated by arrow 401A.

FIG. 4D shows a side view of the intermediate optics 205, referenced as View C-C in FIG. 4A, in accordance with some embodiments. FIG. 4D shows the adhesive 212B disposed between the mechanical block 211B and each of the intermediate optics 205 and the mechanical platform 209. In some embodiments, the expansion and contraction of the bondline thickness of the adhesive 212B causes both the corresponding vertical movement of the array of lenses 206-1 to 206-4 of the intermediate optics 205 relative to the mechanical platform 209, as indicated by arrow 402B, and the corresponding horizontal movement of the array of lenses 206-1 to 206-4 of the intermediate optics 205 relative to the mechanical platform 209, as indicated by arrow 401B.

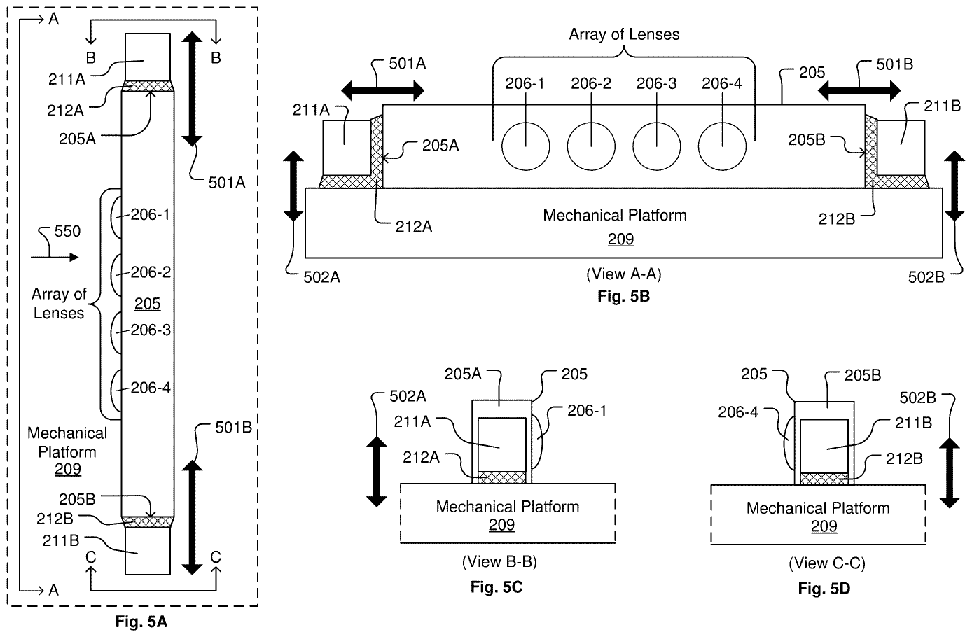

FIG. 5A shows an isolated top view of the intermediate optics 205, with placement of the first set of mechanical blocks 211A and 211B on the ends, respectively, of the array of lenses 206-1 to 206-4 of the intermediate optics 205, in accordance with some embodiments. Specifically, the mechanical block 211A is placed next to a first end 205A of the array of lenses 206-1 to 206-4, where the first end 205A is oriented substantially parallel to a direction of the light propagation through the intermediate optics 205. Also, the mechanical block 211B is placed next to a second end 205B of the array of lenses 206-1 to 206-4, where the second end 205B is oriented substantially parallel to the direction of the light propagation through the intermediate optics 205. In this embodiment, shrinkage and/or expansion of the adhesives 212A and 212B disposed between the first set of mechanical blocks 211A and 211B, respectively, and the intermediate optics 205 causes movement of the array of lenses 206-1 to 206-4 of the intermediate optics 205 in a crosswise direction that extends across a light propagation direction 550, as indicated by arrows 501A and 501B. In some embodiments, the crosswise direction is substantially perpendicular to the light propagation direction 550 through the intermediate optics 205.

FIG. 5B shows a front view of the intermediate optics 205, referenced as View A-A in FIG. 5A, in accordance with some embodiments. FIG. 5B shows the adhesive 212A disposed between the mechanical block 211A and each of the mechanical platform 209 and the intermediate optics 205. FIG. 5B also shows the adhesive 212B disposed between the mechanical block 211B and each of the mechanical platform 209 and the intermediate optics 205. In some embodiments, the adhesives 212A and 212B expand in size with increased temperature and/or increased humidity primarily in the direction of the bondline thickness of the adhesives 212A and 212B. Also, the adhesives 212A and 212B contract with decreased temperature and/or decreased humidity primarily in the direction of the bondline thickness of the adhesives 212A and 212B. Also, in some embodiments, the adhesives 212A and 212B can change shape and/or size during the UV curing process as the bond structure of the adhesives 212A and 212B change. The expansion and contraction of the bondline thickness of the adhesives 212A and 212B causes a corresponding horizontal movement of the array of lenses 206-1 to 206-4 of the intermediate optics 205 relative to the mechanical platform 209, as indicated by arrows 501A and 501B.

In some embodiments, the bondline thickness of the adhesive 212A between the first mechanical block 211A and the intermediate optics 205 is substantially equal to the bondline thickness of the adhesive 212B between the second mechanical block 211B and the intermediate optics 205, such that the horizontal displacement of the first mechanical block 211A relative to the intermediate optics 205 is substantially equal to the horizontal displacement of the second mechanical block 211B relative to the intermediate optics 205 as the bondline thicknesses of the adhesives 212A and 212B change in size with changes in temperature and/or humidity and/or because of UV-curing. In some embodiments, the adhesive 212A is disposed to have a larger bondline thickness on the first end 205A of the array of lenses 206-1 to 206-4 in comparison to the bondline thickness of the adhesive 212B on the second end 205B of the array of lenses 206-1 to 206-4, so as to bias the corresponding horizontal movement of the array of lenses 206-1 to 206-4 toward the second end 205B as the bondline thicknesses of the adhesives 212A and 212B increase in size with increased temperature and/or increased humidity and/or because of UV-curing. Conversely, in some embodiments, the adhesive 212B is disposed to have a larger bondline thickness on the second end 205B of the array of lenses 206-1 to 206-4 in comparison to the bondline thickness of the adhesive 212A on the first end 205A of the array of lenses 206-1 to 206-4, so as to bias the corresponding horizontal movement of the array of lenses 206-1 to 206-4 toward the first end 205A as the bondline thicknesses of the adhesives 212A and 212B increase in size with increased temperature and/or increased humidity and/or because of UV-curing.

The expansion and contraction of the bondline thickness of the adhesives 212A and 212B also causes a corresponding vertical movement of the array of lenses 206-1 to 206-4 of the intermediate optics 205 relative to the mechanical platform 209, as indicated by arrows 502A and 502B. In some embodiments, the bondline thickness of the adhesive 212A between the first mechanical block 211A and the mechanical platform 209 is substantially equal to the bondline thickness of the adhesive 212B between the second mechanical block 211B and the mechanical platform 209, such that the vertical displacement of the first end 205A of the array of lenses 206-1 to 206-4 is substantially equal to the vertical displacement of the second end 205B of the array of lenses 206-1 to 206-4 as the bondline thicknesses of the adhesives 212A and 212B change in size with changes in temperature and/or humidity and/or because of UV-curing. In some embodiments, the adhesive 212A is disposed to have a larger bondline thickness between the first mechanical block 211A and the mechanical platform 209 in comparison to the bondline thickness between the second mechanical block 211B and the mechanical platform 209, so as to bias the corresponding vertical movement of the first end 205A of the array of lenses 206-1 to 206-4 relative to the second end 205B of the array of lenses 206-1 to 206-4 as the bondline thicknesses of the adhesives 212A and 212B change in size with changes in temperature and/or humidity and/or because of UV-curing. Conversely, in some embodiments, the adhesive 212B is disposed to have a larger bondline thickness between the second mechanical block 211B and the mechanical platform 209 in comparison to the bondline thickness between the first mechanical block 211A and the mechanical platform 209, so as to bias the corresponding vertical movement of the second end 205B of the array of lenses 206-1 to 206-4 relative to the first end 205A of the array of lenses 206-1 to 206-4 as the bondline thicknesses of the adhesives 212A and 212B change in size with changes in temperature and/or humidity and/or because of UV-curing.

FIG. 5C shows a side view of the intermediate optics 205, referenced as View B-B in FIG. 5A, in accordance with some embodiments. FIG. 5C shows the adhesive 212A disposed between the mechanical block 211A and the mechanical platform 209. In some embodiments, the expansion and contraction of the bondline thickness of the adhesive 212A causes both the corresponding vertical movement of the array of lenses 206-1 to 206-4 of the intermediate optics 205 relative to the mechanical platform 209, as indicated by arrow 502A, and the corresponding horizontal movement of the array of lenses 206-1 to 206-4 of the intermediate optics 205 relative to the mechanical platform 209, as indicated by arrow 501A.

FIG. 5D shows a side view of the intermediate optics 205, referenced as View C-C in FIG. 5A, in accordance with some embodiments. FIG. 5D shows the adhesive 212B disposed between the mechanical block 211B and the mechanical platform 209. In some embodiments, the expansion and contraction of the bondline thickness of the adhesive 212B causes both the corresponding vertical movement of the array of lenses 206-1 to 206-4 of the intermediate optics 205 relative to the mechanical platform 209, as indicated by arrow 502B, and the corresponding horizontal movement of the array of lenses 206-1 to 206-4 of the intermediate optics 205 relative to the mechanical platform 209, as indicated by arrow 501B. In some embodiments, a force exerted by the first mechanical block 211A on the intermediate optics 205 is substantially equally balanced by a force exerted by the second mechanical block 211B on the intermediate optics 205, such that a net horizontal movement of the intermediate optics 205 in the direction indicated by arrows 501A/501B is essentially zero.

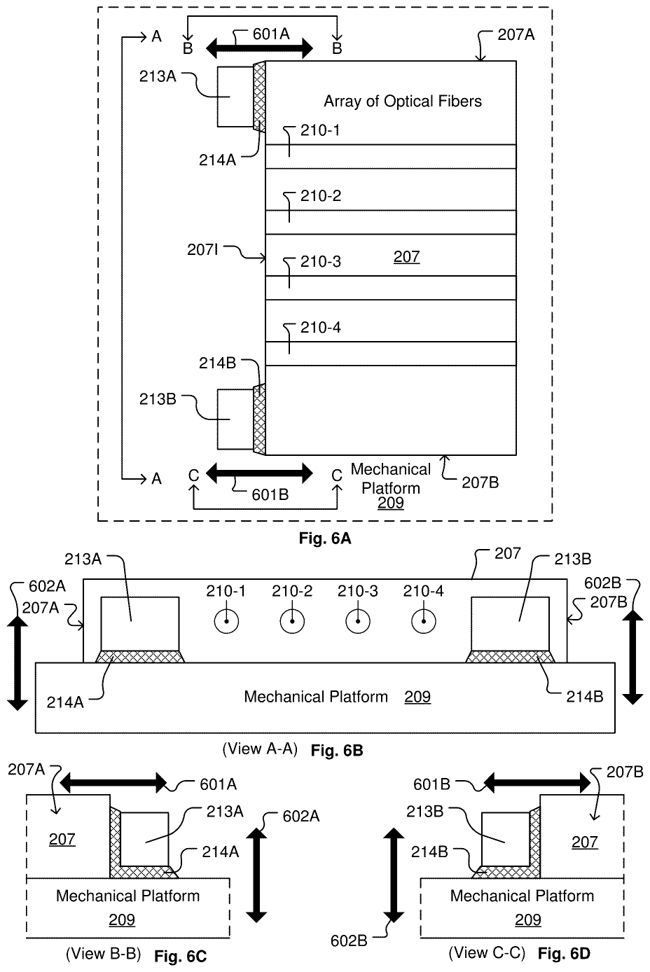

FIG. 6A shows an isolated top view of the receiving optics 207, with placement of the second set of mechanical blocks 213A and 213B on a light input side 207I of the array of optical fibers 210-1 to 210-4 of the receiving optics 207, in accordance with some embodiments. In this embodiment, shrinkage and/or expansion of the adhesives 214A and 214B disposed between the second set of mechanical blocks 213A and 213B, respectively, and the receiving optics 207 causes movement of the array of optical fibers 210-1 to 210-4 of the receiving optics 207 in a direction substantially parallel to the light propagation direction, as indicated by arrows 601A and 601B. In some embodiments, the bondline thickness of the adhesive 214A between the first mechanical block 213A and the receiving optics 207 is substantially equal to the bondline thickness of the adhesive 214B between the second mechanical block 213B and the receiving optics 207, such that the horizontal displacement of the first end 207A of the receiving optics 207 is substantially equal to the horizontal displacement of the second end 207B of the receiving optics 207 as the bondline thicknesses of the adhesives 214A and 214B change in size with changes in temperature and/or humidity and/or because of UV-curing. In some embodiments, the bondline thickness of the adhesive 214A between the mechanical block 213A and the receiving optics 207 is larger than the bondline thickness of the adhesive 214B between the mechanical block 213B and the receiving optics 207, so as to increase the corresponding horizontal movement of the first end 207A of the receiving optics 207 relative to the second end 207B of the receiving optics 207 in response to changes in size of the adhesives 214A and 214B with changes in temperature and/or humidity and/or because of UV-curing. Conversely, in some embodiments, the bondline thickness of the adhesive 214B between the mechanical block 213B and the receiving optics 207 is larger than the bondline thickness of the adhesive 214A between the mechanical block 213A and the receiving optics 207, so as to increase the corresponding horizontal movement of the second end 207B of the receiving optics 207 relative to the first end 207A of the receiving optics 207 in response to changes in size of the adhesives 214A and 214B with changes in temperature and/or humidity and/or because of UV-curing.

FIG. 6B shows a front view of the receiving optics 207, referenced as View A-A in FIG. 6A, in accordance with some embodiments. FIG. 6B shows the adhesive 214A disposed between the mechanical block 213A and the mechanical platform 209. FIG. 6B also shows the adhesive 214B disposed between the mechanical block 213B and the mechanical platform 209. In some embodiments, the adhesives 214A and 214B expand in size with increased temperature and/or increased humidity primarily in the direction of the bondline thickness of the adhesives 214A and 214B. Also, the adhesives 214A and 214B contract with decreased temperature and/or decreased humidity primarily in the direction of the bondline thickness of the adhesives 214A and 214B. Also, in some embodiments, the adhesives 214A and 214B can change shape and/or size during the UV curing process as the bond structure of the adhesives 214A and 214B change. The expansion and contraction of the bondline thickness of the adhesives 214A and 214B causes a corresponding vertical movement of the receiving optics 207 relative to the mechanical platform 209, as indicated by arrows 602A and 602B. In some embodiments, the bondline thickness of the adhesive 214A between the first mechanical block 213A and the mechanical platform 209 is substantially equal to the bondline thickness of the adhesive 214B between the second mechanical block 213B and the mechanical platform 209, such that the vertical displacement of the first end 207A of the receiving optics 207 is substantially equal to the vertical displacement of the second end 207B of the receiving optics 207 as the bondline thicknesses of the adhesives 214A and 214B change in size with changes in temperature and/or humidity and/or because of UV-curing. In some embodiments, the bondline thickness of the adhesive 214A between the mechanical block 213A and the mechanical platform 209 is larger than the bondline thickness of the adhesive 214B between the mechanical block 213B and the mechanical platform 209, so as to increase the corresponding vertical movement of the first end 207A of the receiving optics 207 relative to the second end 207B of the receiving optics 207 in response to changes in size of the adhesives 214A and 214B with changes in temperature and/or humidity and/or because of UV-curing. Conversely, in some embodiments, the bondline thickness of the adhesive 214B between the mechanical block 213B and the mechanical platform 209 is larger than the bondline thickness of the adhesive 214A between the mechanical block 213A and the mechanical platform 209, so as to increase the corresponding horizontal movement of the second end 207B of the receiving optics 207 relative to the first end 207A of the receiving optics 207 in response to changes in size of the adhesives 214A and 214B with changes in temperature and/or humidity and/or because of UV-curing.

FIG. 6C shows a side view of the receiving optics 207, referenced as View B-B in FIG. 6A, in accordance with some embodiments. FIG. 6C shows the adhesive 214A disposed between the mechanical block 213A and each of the receiving optics 207 and the mechanical platform 209. In some embodiments, the expansion and contraction of the bondline thickness of the adhesive 214A causes both the corresponding vertical movement of the receiving optics 207 relative to the mechanical platform 209, as indicated by arrow 602A, and the corresponding horizontal movement of the receiving optics 207 relative to the mechanical platform 209, as indicated by arrow 601A.

FIG. 6D shows a side view of the receiving optics 207, referenced as View C-C in FIG. 6A, in accordance with some embodiments. FIG. 6D shows the adhesive 214B disposed between the mechanical block 213B and each of the receiving optics 207 and the mechanical platform 209. In some embodiments, the expansion and contraction of the bondline thickness of the adhesive 214B causes both the corresponding vertical movement of the receiving optics 207 relative to the mechanical platform 209, as indicated by arrow 602B, and the corresponding horizontal movement of the receiving optics 207 relative to the mechanical platform 209, as indicated by arrow 601B.

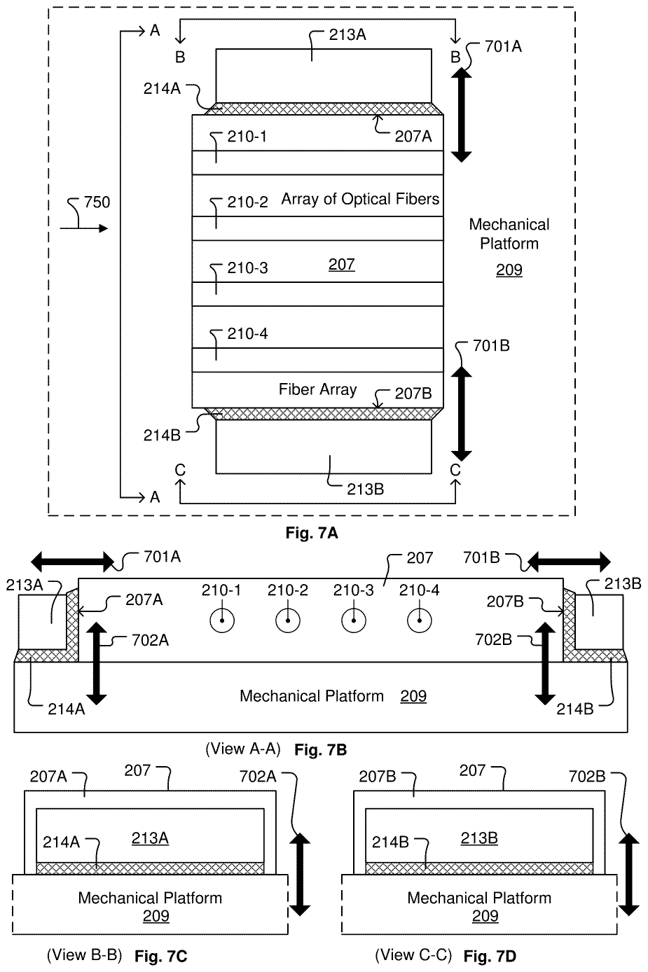

FIG. 7A shows an isolated top view of the receiving optics 207, with placement of the second set of mechanical blocks 213A and 213B on the ends, respectively, of the array of optical fibers 210-4 to 210-4 of the receiving optics 207, in accordance with some embodiments. Specifically, the mechanical block 213A is placed next to the first end 207A of the receiving optics 207, where the first end 207A is oriented substantially parallel to a light propagation direction 750 through the receiving optics 207. Also, the mechanical block 213B is placed next to the second end 207B of the receiving optics 207, where the second end 207B is oriented substantially parallel to the light propagation direction 750 through the receiving optics 207. In this embodiment, shrinkage and/or expansion of the adhesives 214A and 214B disposed between the second set of mechanical blocks 213A and 213B, respectively, and the receiving optics 207 causes movement of the array of optical fibers 210-4 to 210-4 of the receiving optics 207 in a crosswise direction that extends across the light propagation direction 750, as indicated by arrows 701A and 701B. In some embodiments, the crosswise direction is substantially perpendicular to the light propagation direction 750 through the receiving optics 207.

FIG. 7B shows a front view of the receiving optics 207, referenced as View A-A in FIG. 7A, in accordance with some embodiments. FIG. 7B shows the adhesive 214A disposed between the mechanical block 213A and each of the mechanical platform 209 and the receiving optics 207. FIG. 7B also shows the adhesive 214B disposed between the mechanical block 213B and each of the mechanical platform 209 and the receiving optics 207. In some embodiments, the adhesives 214A and 214B expand in size with increased temperature and/or increased humidity primarily in the direction of the bondline thickness of the adhesives 214A and 214B. Also, the adhesives 214A and 214B contract with decreased temperature and/or decreased humidity primarily in the direction of the bondline thickness of the adhesives 214A and 214B. Also, in some embodiments, the adhesives 214A and 214B can change shape and/or size during the UV curing process as the bond structure of the adhesives 214A and 214B change. The expansion and contraction of the bondline thickness of the adhesives 214A and 214B causes a corresponding horizontal movement of the receiving optics 207 relative to the mechanical platform 209, as indicated by arrows 701A and 701B.

In some embodiments, the bondline thickness of the adhesive 214A between the first mechanical block 213A and the receiving optics 207 is substantially equal to the bondline thickness of the adhesive 214B between the second mechanical block 213B and the receiving optics 207, such that the horizontal displacement of the first mechanical block 213A relative to the receiving optics 207 is substantially equal to the horizontal displacement of the second mechanical block 213B relative to the receiving optics 207 as the bondline thicknesses of the adhesives 214A and 214B change in size with changes in temperature and/or humidity and/or because of UV-curing. In some embodiments, the adhesive 214A is disposed to have a larger bondline thickness on the first end 207A of the receiving optics 207 in comparison to the bondline thickness of the adhesive 214B on the second end 207B of the receiving optics 207, so as to bias the corresponding horizontal movement of the receiving optics 207 toward the second end 207B as the bondline thicknesses of the adhesives 214A and 214B increase in size with increased temperature and/or increased humidity and/or because of UV-curing. Conversely, in some embodiments, the adhesive 214B is disposed to have a larger bondline thickness on the second end 207B of the receiving optics 207 in comparison to the bondline thickness of the adhesive 214A on the first end 207A of the receiving optics 207, so as to bias the corresponding horizontal movement of the receiving optics toward the first end 207A as the bondline thicknesses of the adhesives 214A and 214B increase in size with increased temperature and/or increased humidity and/or because of UV-curing.

The expansion and contraction of the bondline thickness of the adhesives 214A and 214B also causes a corresponding vertical movement of the receiving optics 207 relative to the mechanical platform 209, as indicated by arrows 702A and 702B. In some embodiments, the bondline thickness of the adhesive 214A between the first mechanical block 213A and the mechanical platform 209 is substantially equal to the bondline thickness of the adhesive 214B between the second mechanical block 213B and the mechanical platform 209, such that the vertical displacement of the first end 207A of the receiving optics 207 is substantially equal to the vertical displacement of the second end 207B of the receiving optics 207 as the bondline thicknesses of the adhesives 214A and 214B change in size with changes in temperature and/or humidity and/or because of UV-curing. In some embodiments, the adhesive 214A is disposed to have a larger bondline thickness between the first mechanical block 213A and the mechanical platform 209 in comparison to the bondline thickness between the second mechanical block 213B and the mechanical platform 209, so as to bias the corresponding vertical movement of the first end 207A of the receiving optics 207 relative to the second end 207B of the receiving optics 207 as the bondline thicknesses of the adhesives 214A and 214B change in size with changes in temperature and/or humidity and/or because of UV-curing. Conversely, in some embodiments, the adhesive 214B is disposed to have a larger bondline thickness between the second mechanical block 213B and the mechanical platform 209 in comparison to the bondline thickness between the first mechanical block 213A and the mechanical platform 209, so as to bias the corresponding vertical movement of the second end 207B of the receiving optics 207 relative to the first end 207A of the receiving optics 207 as the bondline thicknesses of the adhesives 214A and 214B change in size with changes in temperature and/or humidity and/or because of UV-curing.

FIG. 7C shows a side view of the receiving optics 207, referenced as View B-B in FIG. 7A, in accordance with some embodiments. FIG. 7C shows the adhesive 214A disposed between the mechanical block 213A and the mechanical platform 209. In some embodiments, the expansion and contraction of the bondline thickness of the adhesive 214A causes both the corresponding vertical movement of the receiving optics 207 relative to the mechanical platform 209, as indicated by arrow 702A, and the corresponding horizontal movement of the receiving optics 207 relative to the mechanical platform 209, as indicated by arrow 701A.

FIG. 7D shows a side view of the receiving optics 207, referenced as View C-C in FIG. 7A, in accordance with some embodiments. FIG. 7D shows the adhesive 214B disposed between the mechanical block 213B and the mechanical platform 209. In some embodiments, the expansion and contraction of the bondline thickness of the adhesive 214B causes both the corresponding vertical movement of the receiving optics 207 relative to the mechanical platform 209, as indicated by arrow 702B, and the corresponding horizontal movement of the receiving optics 207 relative to the mechanical platform 209, as indicated by arrow 701B. In some embodiments, a force exerted by the first mechanical block 213A on the receiving optics 207 is substantially equally balanced by a force exerted by the second mechanical block 213B on the receiving optics 207, such that a net horizontal movement of the receiving optics 207 in the direction indicated by arrows 701A/701B is essentially zero.

FIGS. 4A-4D, 5A-5D, 6A-6D, and 7A-7D show that the mechanical blocks, e.g., 211A/211B and 213A/213B, can be placed at different positions relative to the optical component to which they are attached, in order to directionally control the impact of adhesive 212A/212B and 214A/214B shrinkage and expansion on the optical component. In some embodiments, the mechanical blocks, e.g., 211A/211B and 213A/213B, are positioned relative to the optical components to which they are attached so that the adhesive shrinkage and expansion over time will occur in a direction of least optical alignment sensitivity of the optical components, so as to minimize the impact of adhesive shrinkage and expansion on the optical alignment of the optical components. More specifically, if the optical alignment sensitivity is lower for perturbations in the positions of the intermediate optics 205 and/or receiving optics 207 in the direction of light propagation, then the configurations of FIGS. 4A-4D and 6A-6D may be more beneficial than the configurations of FIGS. 5A-5D and 7A-7D. However, if the optical alignment sensitivity is greater for perturbations in the positions of the intermediate optics 205 and/or receiving optics 207 in the direction of light propagation, as opposed to across the direction of light propagation, then the configurations of FIGS. 5A-5D and 7A-7D will be more beneficial than the configurations of FIGS. 4A-4D and 6A-6D.

It should be understood that the mechanical blocks, e.g., 211A/211B and 213A/213B, can be added onto the mechanical platform 209 (substrate, interposer, etc.) after completion of the optical alignment of optical components on the mechanical platform 209. In some embodiments, the mechanical blocks 211A/211B, 213A/213B are pushed towards the corresponding optical component to which they are attached (in opposing directions) in order to squeeze out excess adhesive 212A/212B, 214A/214B, so as to minimize a bondline thickness of the adhesive 212A/212B, 214A/214B between the mechanical blocks 211A/211B, 213A/213B and the corresponding optical component to which they are attached, which in turn reduces an amount of shrinkage and/or expansion of the adhesive 212A/212B, 214A/214B in response to changes in temperature and/or humidity and/or because of UV-curing. In some embodiments, disposing the adhesive 212A/212B, 214A/214B to have a small bondline thicknesses is beneficial because the magnitude of shrinkage and/or expansion of the adhesive 212A/212B, 214A/214B is proportional to the bondline thickness of the adhesive 212A/212B, 214A/214B. For example, in some embodiments, the amount of expansion of the adhesive 212A/212B, 214A/214B due to hygroscopic swelling is proportional to the bondline thickness of the adhesive 212A/212B, 214A/214B.

It should be understood that use of the mechanical blocks 211A/211B, 213A/213B avoids having to dispose adhesive 212A/212B, 214A/214B between the optical components (intermediate optics 205 and receiving optics 207) and the mechanical platform 209, which avoids adverse issues caused by the dimensional tolerances/variations of the optical components, such as difficulty in achieving a minimum bondline thickness of the adhesive 212A/212B, 214A/214B between the optical components and the mechanical platform 209. In some embodiments, the intermediate optics 205 are secured to the mechanical blocks 211A and 211B by way of the adhesive 212A and 212B, respectively, and the mechanical blocks 211A and 211B are secured to the mechanical platform 209 by way of the adhesive 212A and 212B, respectively, but the intermediate optics 205 are not themselves secured to the mechanical platform 209. In some embodiments, the receiving optics 207 are secured to the mechanical blocks 213A and 213B by way of the adhesive 214A and 214B, respectively, and the mechanical blocks 213A and 213B are secured to the mechanical platform 209 by way of the adhesive 214A and 214B, respectively, but the receiving optics 207 are not themselves secured to the mechanical platform 209.

In some embodiments, the optical alignment tolerance between the optical components (light source 203, intermediate optics 205, and receiving optics 207) in the optical modules 201 and 301 can be direction-dependent, such that the optical alignment tolerance is smaller or larger in certain directions as compared to other directions. As discussed above, in some embodiments, a physical shift of the adhesive 212A/212B, 214A/214B (due shrinkage or expansion) has a directional relationship with the bondline thickness of the adhesive 212A/212B, 214A/214B. For example, in the case of hygroscopic swelling of the adhesive 212A/212B, 214A/214B, the adhesive 212A/212B, 214A/214B tends to swell predominantly in the direction parallel to the adhesive 212A/212B, 214A/214B bondline thickness direction. In some embodiments, placement of the mechanical blocks 211A/211B and 213A/213B relative to the optical components (intermediate optics 205, receiving optics 207) to which they are attached by way of adhesive 212A/212B, 214A/214B is done such that the physical shift of the adhesive 212A/212B, 214A/214B caused by shape/volume changes of the adhesive 212A/212B, 214A/214B over time is in the direction of least optical alignment sensitivity of the optical components, so as to minimize the optical coupling loss due to the physical shift of the adhesive 212A/212B, 214A/214B.

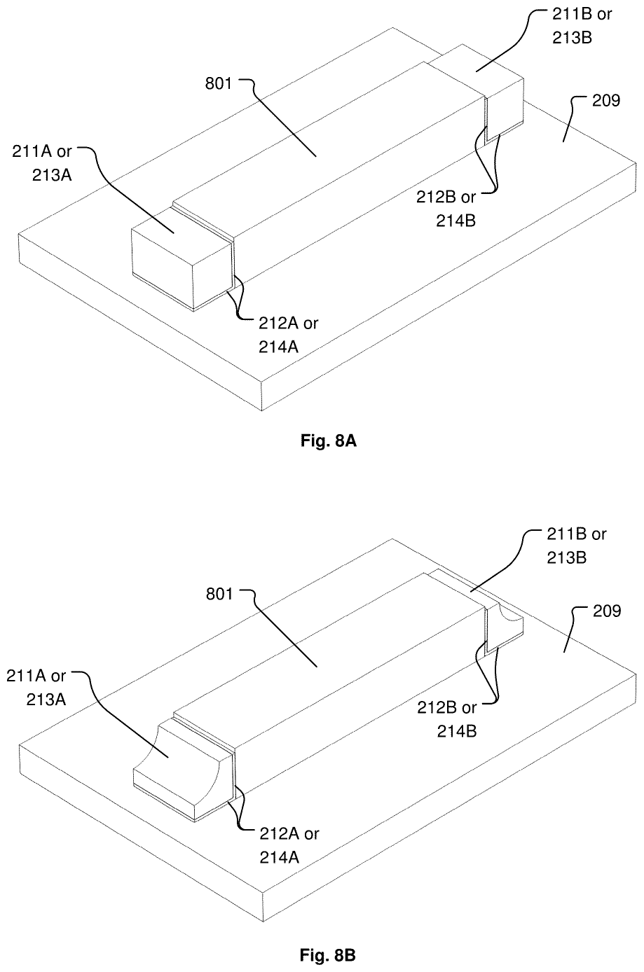

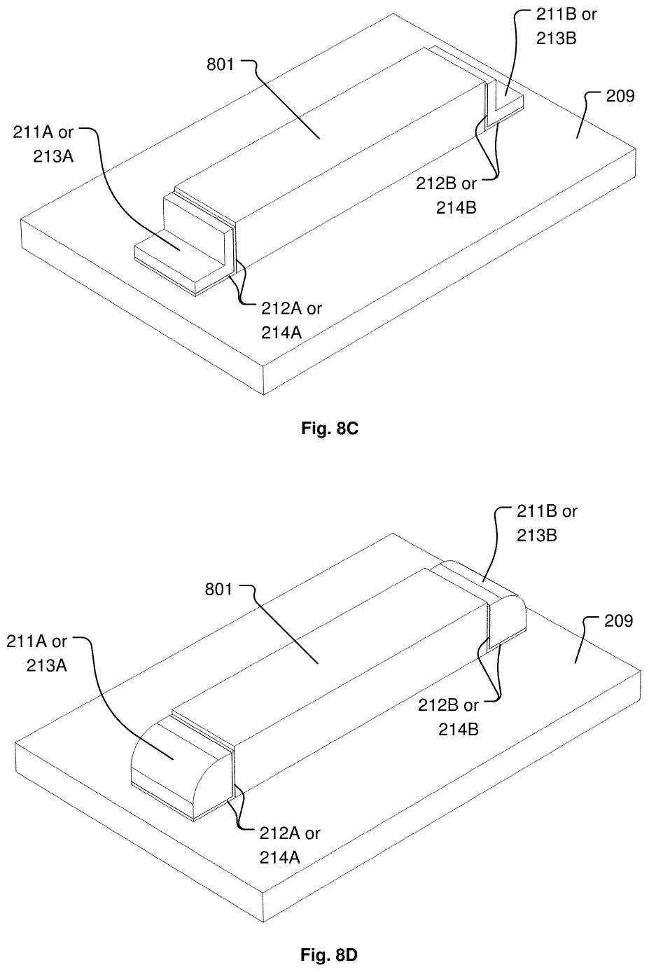

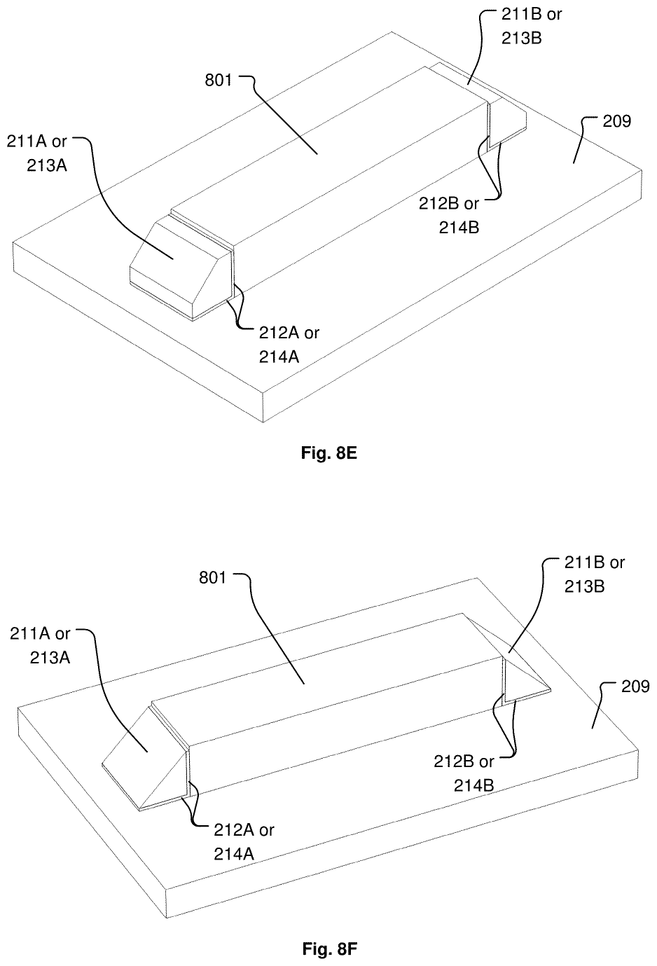

In various embodiments, the mechanical blocks 211A/211B and 213A/213B can be configured in different ways for various reasons. FIG. 8A shows an example in which the mechanical blocks 211A/211B and 213A/213B are configured as rectangular-shaped blocks, such as depicted in the examples of FIGS. 4A-4D, 5A-5D, 6A-6D, and 7A-7D, in accordance with some embodiments. In the example of FIG. 8A, the mechanical blocks 211A/211B and 213A/213B are positioned at the ends of the optical component 801. The adhesive 212A/214A is disposed between the mechanical blocks 211A/213A and the optical component 801. The adhesive 212B/214B is disposed between the mechanical blocks 211B/213B and the optical component 801. It should be understood that the in various embodiments the mechanical blocks 211A/211B and 213A/213B can be positioned against essentially any vertical side of the optical component 801 and the horizontal surface of the mechanical platform 209, as needed for the particular photonic application. In various embodiments, the optical component 801 can be essentially any optical component through which light is conveyed for optical data communication purposes. In some embodiments, the optical component 801 is either the intermediate optics 205 or receiving optics 207 as described with regard to FIG. 2.

FIG. 8B shows an example in which the mechanical blocks 211A/211B and 213A/213B are configured as rectangular-shaped blocks that have a concave fillet formed along an edge of the mechanical blocks 211A/211B and 213A/213B that is positioned farthest away from both the optical component 801 and the mechanical platform 209, in accordance with some embodiments. In some embodiments, the concave fillet formed along the edge of the mechanical blocks 211A/211B and 213A/213B reduces an overall space occupied by the mechanical blocks 211A/211B and 213A/213B to facilitate packaging of the optical module 201/203. The concave fillet formed along the edge of the mechanical blocks 211A/211B and 213A/213B provides a mechanical strength necessary to withstand the forces applied to the mechanical blocks 211A/211B and 213A/213B by one or more of the mechanical platform 209, the optical component 801, and the adhesive 212A/214A/212B/214B.

FIG. 8C shows an example in which the mechanical blocks 211A/211B and 213A/213B are configured as L-shaped blocks, in accordance with some embodiments. In some embodiments, the L-shape of the mechanical blocks 211A/211B and 213A/213B reduces an overall space occupied by the mechanical blocks 211A/211B and 213A/213B to facilitate packaging of the optical module 201/203. The L-shape of the mechanical blocks 211A/211B and 213A/213B provides a mechanical strength necessary to withstand the forces applied to the mechanical blocks 211A/211B and 213A/213B by one or more of the mechanical platform 209, the optical component 801, and the adhesive 212A/214A/212B/214B.

FIG. 8D shows an example in which the mechanical blocks 211A/211B and 213A/213B are configured as rectangular-shaped blocks that have a convex fillet formed along an edge of the mechanical blocks 211A/211B and 213A/213B that is positioned farthest away from both the optical component 801 and the mechanical platform 209, in accordance with some embodiments. In some embodiments, the convex fillet formed along the edge of the mechanical blocks 211A/211B and 213A/213B reduces an overall space occupied by the mechanical blocks 211A/211B and 213A/213B to facilitate packaging of the optical module 201/203. The convex fillet formed along the edge of the mechanical blocks 211A/211B and 213A/213B provides a mechanical strength necessary to withstand the forces applied to the mechanical blocks 211A/211B and 213A/213B by one or more of the mechanical platform 209, the optical component 801, and the adhesive 212A/214A/212B/214B.

FIG. 8E shows an example in which the mechanical blocks 211A/211B and 213A/213B are configured as rectangular-shaped blocks that have a chamfer formed along an edge of the mechanical blocks 211A/211B and 213A/213B that is positioned farthest away from both the optical component 801 and the mechanical platform 209, in accordance with some embodiments. In some embodiments, the chamfer formed along the edge of the mechanical blocks 211A/211B and 213A/213B reduces an overall space occupied by the mechanical blocks 211A/211B and 213A/213B to facilitate packaging of the optical module 201/203. The chamfer formed along the edge of the mechanical blocks 211A/211B and 213A/213B provides a mechanical strength necessary to withstand the forces applied to the mechanical blocks 211A/211B and 213A/213B by one or more of the mechanical platform 209, the optical component 801, and the adhesive 212A/214A/212B/214B.

FIG. 8F shows an example in which the mechanical blocks 211A/211B and 213A/213B are configured as triangular-shaped blocks that have a bevel formed along an edge of the mechanical blocks 211A/211B and 213A/213B that is positioned farthest away from both the optical component 801 and the mechanical platform 209, in accordance with some embodiments. In some embodiments, the bevel formed along the edge of the mechanical blocks 211A/211B and 213A/213B reduces an overall space occupied by the mechanical blocks 211A/211B and 213A/213B to facilitate packaging of the optical module 201/203. The bevel formed along the edge of the mechanical blocks 211A/211B and 213A/213B provides a mechanical strength necessary to withstand the forces applied to the mechanical blocks 211A/211B and 213A/213B by one or more of the mechanical platform 209, the optical component 801, and the adhesive 212A/214A/212B/214B.

In various embodiments, the mechanical blocks 211A/211B and 213A/213B can be formed from various materials that have sufficient mechanical strength, sufficient chemical compatibility, and sufficient thermal compatibility for the particular optical module configuration in which the mechanical blocks 211A/211B and 213A/213B are utilized. In some embodiments, the mechanical blocks 211A/211B and 213A/213B are formed of a metal, such as aluminum, stainless steel, or an alloy, among other metals. In some embodiments, the mechanical blocks 211A/211B and 213A/213B are formed of a ceramic material, such as alumina, silicon nitride, or silicon carbide, among other ceramics. In some embodiments, the mechanical blocks 211A/211B and 213A/213B are formed of a composite material, such as carbon fiber reinforced polymer (CFRP) or glass fiber reinforced polymer (GFRP), among other composite materials. In some embodiments, the mechanical blocks 211A/211B and 213A/213B are formed of a polymer or a plastic, such as polyethylene, polypropylene, polytetrafluoroethylene (PTFE), among others. In some embodiments, the mechanical blocks 211A/211B and 213A/213B are formed of glass or quartz or sapphire. In some embodiments, the mechanical blocks 211A/211B and 213A/213B are formed of a low coefficient of thermal expansion (CTE) material (CTE less than or equal to about 1×10⁻⁶/K), such as the INVAR™ alloy or the ZERODUR™ glass-ceramic material.

FIG. 9 shows a flowchart of a method for assembling an optical module, in accordance with some embodiments. The method includes an operation 901 for disposing one or more optical components (e.g., light source 203, intermediate optics 205, receiving optics 207) onto the mechanical platform 209 in an optically aligned configuration. The method then proceeds with an operation 903 for affixing at least one mechanical block (e.g., 211A/211B, 213A/213B) to each of the one or more optical components and to the mechanical platform 209 without disturbing the optical alignment of the one or more optical components. In some embodiments, two mechanical blocks (e.g., 211A/211B, 213A/213B) are affixed to a given optical component. In some embodiments, said two mechanical blocks (e.g., 211A/211B, 213A/213B) are affixed at opposite sides of the given optical component so that they can be pushed toward the given optical component in opposing directions. In some embodiments, the operation 903 includes disposing an adhesive (e.g., 212A/212B, 214A/214B) between the at least one mechanical block (e.g., 211A/211B, 213A/213B) the one or more optical components and the mechanical platform 209. In some embodiments, the adhesive is a UV-curable adhesive. In some embodiments, the adhesive is an epoxy or glue material that can be UV snap-cured. In some embodiments, the mechanical blocks (e.g., 211A/211B, 213A/213B) are sized and shaped based on the size and shape of the optical components to which they are affixed. In some embodiments, the mechanical blocks (e.g., 211A/211B, 213A/213B) are configured to have surfaces that satisfy minimum specifications for cleanliness, flatness, and roughness. In some embodiments, the method includes an optional operation 905 for pushing of mechanical blocks (e.g., 211A/211B, 213A/213B) on opposite sides of a given optical component toward each other (before UV curing of the adhesive) so as to minimize a bondline thickness of adhesive (e.g., 212A/212B, 214A/214B) between the mechanical blocks and the given optical component. In some embodiments, the optical components are secured in place relative to the mechanical platform 209 by way of the mechanical blocks (e.g., 211A/211B, 213A/213B), without having adhesive (e.g., 212A/212B, 214A/214B) disposed between the optical components and the mechanical platform 209. In other embodiments, some amount of adhesive (e.g., 212A/212B, 214A/214B) is disposed between the optical components and the mechanical platform 209.

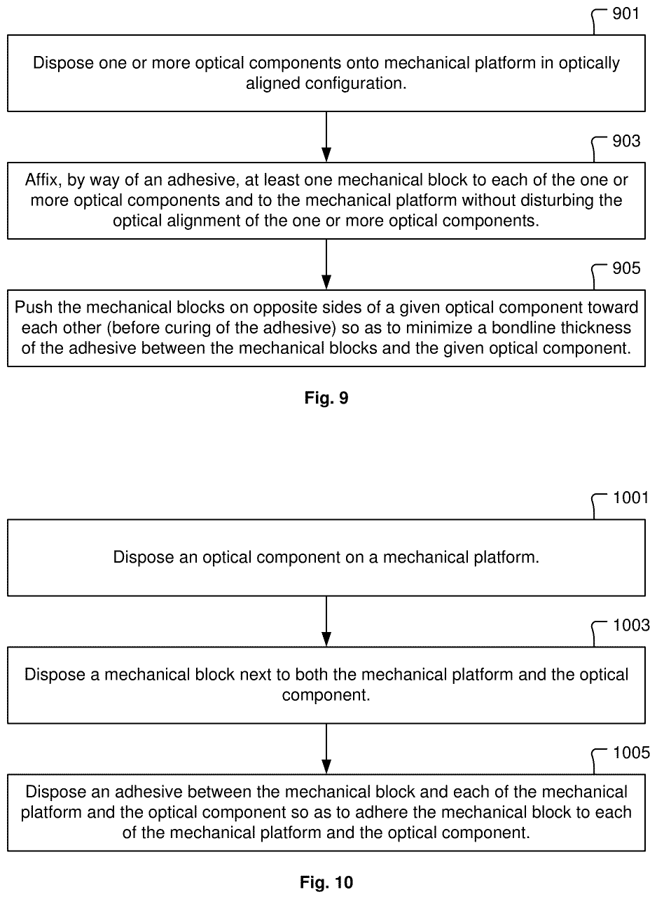

FIG. 10 shows a flowchart of a method for assembling an optical module, in accordance with some embodiments. The method includes an operation 1001 for disposing an optical component on a mechanical platform. The method includes an operation 1003 for disposing a mechanical block next to both the mechanical platform and the optical component. The method includes an operation 1005 for disposing an adhesive between the mechanical block and each of the mechanical platform and the optical component so as to adhere the mechanical block to each of the mechanical platform and the optical component.

In some embodiments, said optical component in the method of FIG. 10 is a first optical component. In these embodiments, the method of FIG. 10 also includes disposing a second optical component on the mechanical platform in optical alignment with the first optical component. Also, in some embodiments, said mechanical block in the method of FIG. 10 is a first mechanical block positioned next to a first side of the first optical component at a first end of the first optical component. In some embodiments, the first side the first optical component is a light incidence side of the first optical component. In these embodiments, the method of FIG. 10 also includes disposing a second mechanical block next to both the mechanical platform and the first optical component. The second mechanical block is positioned next to the first side of the first optical component at a second end of the first optical component. In some embodiments, said adhesive in the method of FIG. 10 is a first adhesive. In these embodiments, the method of FIG. 10 also includes disposing a second adhesive between the second mechanical block and each of the mechanical platform and the first optical component so as to adhere the second mechanical block to each of the mechanical platform and the first optical component. In some embodiments, each of the first adhesive and the second adhesive is not disposed between the first optical component and the mechanical platform.

In some embodiments, the method of FIG. 10 also includes disposing a third mechanical block next to both the mechanical platform and the second optical component at a first end of the second optical component. Also, in these embodiments, the method of FIG. 10 includes disposing a third adhesive between the third mechanical block and each of the mechanical platform and the second optical component so as to adhere the third mechanical block to each of the mechanical platform and the second optical component. Also, in these embodiments, the method of FIG. 10 includes disposing a fourth mechanical block next to both the mechanical platform and the second optical component at a second end of the second optical component. Also, in these embodiments, the method of FIG. 10 includes disposing a fourth adhesive between the fourth mechanical block and each of the mechanical platform and the second optical component so as to adhere the fourth mechanical block to each of the mechanical platform and the second optical component. In some embodiments, each of the third adhesive and the fourth adhesive is not disposed between the second optical component and the mechanical platform. In some embodiments, each of the first, second, third, and fourth adhesives is snap-cured, such as by irradiation with UV light, after each of the first and second mechanical blocks are positioned next to the first optical component, and after the third and fourth mechanical blocks are positioned next to the second optical component, and after the first optical component and the second optical component are optically aligned with each other. In some embodiments of the method of FIG. 10, each of a bondline thickness of the first adhesive and a bondline thickness of the second adhesive extends in a direction substantially parallel to a light propagation direction through the first optical component. Also, in some embodiments of the method of FIG. 10, each of a bondline thickness of the third adhesive and a bondline thickness of the fourth adhesive extends in a direction substantially perpendicular to a light propagation direction through the second optical component.

In some embodiments of the method of FIG. 10, the second optical component includes is a plurality of optical fibers, and the first optical component includes a plurality of lenses configured to respectively receive a plurality of light beams. In these embodiments, the method includes optically aligning the plurality of lenses to respectively focus the plurality of light beams into the plurality of optical fibers. In some embodiments, the method of FIG. 10 includes disposing a light source on the mechanical platform in optical alignment with the first optical component so that the light source conveys the plurality of light beams into the plurality of lenses of the first optical component. In some embodiments, the method of FIG. 10 includes disposing a planar lightwave circuit on the mechanical platform between the first optical component and the second optical component, such that the planar lightwave circuit is optically aligned with both the first optical component and the second optical component to convey light output from the plurality of lenses of the first optical component into the plurality of optical fibers of the second optical component.

Various embodiments are disclosed herein for an optical module that includes a mechanical platform with an optical component disposed on the mechanical platform. At least one mechanical block is disposed next to both the mechanical platform and the optical component. An adhesive is disposed between the at least one mechanical block and each of the mechanical platform and the optical component so as to adhere the at least one mechanical block to each of the mechanical platform and the optical component.

In some embodiments, said optical component is a first optical component, and the optical module includes a second optical component disposed on the mechanical platform, where the first optical component is positioned in optical alignment with the second optical component. In some embodiments, the at least one mechanical block includes a first mechanical block and a second mechanical block, the first mechanical block positioned next to a first side of the first optical component at a first end of the first optical component, the second mechanical block positioned next to the first side of the first optical component at a second end of the first optical component, wherein said adhesive is a first adhesive, wherein the optical module includes a second adhesive disposed between the second mechanical block and each of the mechanical platform and the first optical component so as to adhere the second mechanical block to each of the mechanical platform and the first optical component. In some embodiments, the first side the first optical component is a light incidence side of the first optical component. In some embodiments, each of the first adhesive and the second adhesive is not disposed between the first optical component and the mechanical platform.

In some embodiments, a third mechanical block is disposed next to both the mechanical platform and the second optical component at a first end of the second optical component. Also, a third adhesive is disposed between the third mechanical block and each of the mechanical platform and the second optical component so as to adhere the third mechanical block to each of the mechanical platform and the second optical component. Also, a fourth mechanical block is disposed next to both the mechanical platform and the second optical component at a second end of the second optical component. Also, a fourth adhesive is disposed between the fourth mechanical block and each of the mechanical platform and the second optical component so as to adhere the fourth mechanical block to each of the mechanical platform and the second optical component. In some embodiments, each of the third adhesive and the fourth adhesive is not disposed between the second optical component and the mechanical platform. In some embodiments, each of a bondline thickness of the first adhesive and a bondline thickness of the second adhesive extends in a direction substantially parallel to a light propagation direction through the first optical component. In some embodiments, each of a bondline thickness of the third adhesive and a bondline thickness of the fourth adhesive extends in a direction substantially perpendicular to a light propagation direction through the second optical component.

In some embodiments, the second optical component includes is a plurality of optical fibers, and the first optical component includes a plurality of lenses configured to respectively receive a plurality of light beams. The plurality of lenses is configured to respectively focus the plurality of light beams into the plurality of optical fibers. In some embodiments, a light source is disposed on the mechanical platform in optical alignment with the first optical component. The light source is configured to generate and convey the plurality of light beams into the plurality of lenses of the first optical component. In some embodiments, a planar lightwave circuit is disposed on the mechanical platform between the first optical component and the second optical component. The planar lightwave circuit is optically aligned with both the first optical component and the second optical component. The planar lightwave circuit is configured to convey light output from the plurality of lenses of the first optical component into the plurality of optical fibers of the second optical component.

The foregoing description of the embodiments has been provided for purposes of illustration and description, and is not intended to be exhaustive or limiting. Individual elements or features of a particular embodiment are generally not limited to that particular embodiment, but, where applicable, are interchangeable and can be used in a selected embodiment, even if not specifically shown or described. In this manner, one or more features from one or more embodiments disclosed herein can be combined with one or more features from one or more other embodiments disclosed herein to form another embodiment that is not explicitly disclosed herein, but rather that is implicitly disclosed herein. This other embodiment may also be varied in many ways. Such embodiment variations are not to be regarded as a departure from the disclosure herein, and all such embodiment variations and modifications are intended to be included within the scope of the disclosure provided herein.

Although some method operations may be described in a specific order herein, it should be understood that other housekeeping operations may be performed in between method operations, and/or method operations may be adjusted so that they occur at slightly different times or simultaneously or may be distributed in a system which allows the occurrence of the processing operations at various intervals associated with the processing, as long as the processing of the method operations are performed in a manner that provides for successful implementation of the method.

Although the foregoing embodiments have been described in some detail for purposes of clarity of understanding, it will be apparent that certain changes and modifications can be practiced within the scope of the appended claims. Accordingly, the embodiments disclosed herein are to be considered as illustrative and not restrictive, and are therefore not to be limited to just the details given herein, but may be modified within the scope and equivalents of the appended claims.

What is claimed is:

1. An optical module, comprising:
a mechanical platform;
an optical component disposed on the mechanical platform;
at least one mechanical block disposed next to both the mechanical platform and the optical component; and
an adhesive disposed between the at least one mechanical block and each of the mechanical platform and the optical component so as to adhere the at least one mechanical block to each of the mechanical platform and the optical component.

2. The optical module as recited in claim 1, wherein said optical component is a first optical component, the optical module including a second optical component disposed on the mechanical platform, wherein the first optical component is positioned in optical alignment with the second optical component.

3. The optical module as recited in claim 2, wherein the at least one mechanical block includes a first mechanical block and a second mechanical block, the first mechanical block positioned next to a first side of the first optical component at a first end of the first optical component, the second mechanical block positioned next to the first side of the first optical component at a second end of the first optical component, wherein said adhesive is a first adhesive, wherein the optical module includes a second adhesive disposed between the second mechanical block and each of the mechanical platform and the first optical component so as to adhere the second mechanical block to each of the mechanical platform and the first optical component.

4. The optical module as recited in claim 3, wherein the first side the first optical component is a light incidence side of the first optical component.

5. The optical module as recited in claim 3, wherein each of the first adhesive and the second adhesive is not disposed between the first optical component and the mechanical platform.

6. The optical module as recited in claim 3, further comprising:
a third mechanical block disposed next to both the mechanical platform and the second optical component at a first end of the second optical component;
a third adhesive disposed between the third mechanical block and each of the mechanical platform and the second optical component so as to adhere the third mechanical block to each of the mechanical platform and the second optical component;
a fourth mechanical block disposed next to both the mechanical platform and the second optical component at a second end of the second optical component; and
a fourth adhesive disposed between the fourth mechanical block and each of the mechanical platform and the second optical component so as to adhere the fourth mechanical block to each of the mechanical platform and the second optical component.

7. The optical module as recited in claim 6, wherein each of the third adhesive and the fourth adhesive is not disposed between the second optical component and the mechanical platform.

8. The optical module as recited in claim 6, wherein each of a bondline thickness of the first adhesive and a bondline thickness of the second adhesive extends in a direction substantially parallel to a light propagation direction through the first optical component.

9. The optical module as recited in claim 8, wherein each of a bondline thickness of the third adhesive and a bondline thickness of the fourth adhesive extends in a direction substantially perpendicular to a light propagation direction through the second optical component.

10. The optical module as recited in claim 6, wherein the second optical component includes is a plurality of optical fibers, and wherein the first optical component includes a plurality of lenses configured to respectively receive a plurality of light beams, the plurality of lenses configured to respectively focus the plurality of light beams into the plurality of optical fibers.

11. The optical module as recited in claim 10, further comprising:
a light source disposed on the mechanical platform in optical alignment with the first optical component, the light source configured to generate and convey the plurality of light beams into the plurality of lenses of the first optical component.

12. The optical module as recited in claim 11, further comprising:
a planar lightwave circuit disposed on the mechanical platform between the first optical component and the second optical component, the planar lightwave circuit optically aligned with both the first optical component and the second optical component, the planar lightwave circuit configured to convey light output from the plurality of lenses of the first optical component into the plurality of optical fibers of the second optical component.

13. A method for assembling an optical module, comprising:
disposing an optical component on a mechanical platform;
disposing a mechanical block next to both the mechanical platform and the optical component; and
disposing an adhesive between the mechanical block and each of the mechanical platform and the optical component so as to adhere the mechanical block to each of the mechanical platform and the optical component.

14. The method as recited in claim 13, wherein said optical component is a first optical component, wherein the method includes disposing a second optical component on the mechanical platform in optical alignment with the first optical component.

15. The method as recited in claim 14, wherein said mechanical block is a first mechanical block positioned next to a first side of the first optical component at a first end of the first optical component, wherein the method includes disposing a second mechanical block next to both the mechanical platform and the first optical component, the second mechanical block positioned next to the first side of the first optical component at a second end of the first optical component, wherein said adhesive is a first adhesive, wherein the method includes disposing a second adhesive between the second mechanical block and each of the mechanical platform and the first optical component so as to adhere the second mechanical block to each of the mechanical platform and the first optical component.

16. The method as recited in claim 15, wherein the first side the first optical component is a light incidence side of the first optical component.

17. The method as recited in claim 15, wherein each of the first adhesive and the second adhesive is not disposed between the first optical component and the mechanical platform.

18. The method as recited in claim 15, further comprising:
disposing a third mechanical block next to both the mechanical platform and the second optical component at a first end of the second optical component;
disposing a third adhesive between the third mechanical block and each of the mechanical platform and the second optical component so as to adhere the third mechanical block to each of the mechanical platform and the second optical component;
disposing a fourth mechanical block next to both the mechanical platform and the second optical component at a second end of the second optical component; and
disposing a fourth adhesive between the fourth mechanical block and each of the mechanical platform and the second optical component so as to adhere the fourth mechanical block to each of the mechanical platform and the second optical component.

19. The method as recited in claim 18, wherein each of the third adhesive and the fourth adhesive is not disposed between the second optical component and the mechanical platform.

20. The method as recited in claim 18, wherein each of a bondline thickness of the first adhesive and a bondline thickness of the second adhesive extends in a direction substantially parallel to a light propagation direction through the first optical component.

21. The method as recited in claim 20, wherein each of a bondline thickness of the third adhesive and a bondline thickness of the fourth adhesive extends in a direction substantially perpendicular to a light propagation direction through the second optical component.

22. The method as recited in claim 18, wherein the second optical component includes is a plurality of optical fibers, and wherein the first optical component includes a plurality of lenses configured to respectively receive a plurality of light beams, wherein the method includes optically aligning the plurality of lenses to respectively focus the plurality of light beams into the plurality of optical fibers.

23. The method as recited in claim 22, further comprising:
disposing a light source on the mechanical platform in optical alignment with the first optical component so that the light source conveys the plurality of light beams into the plurality of lenses of the first optical component.

24. The method as recited in claim 23, further comprising:
disposing a planar lightwave circuit on the mechanical platform between the first optical component and the second optical component, such that the planar lightwave circuit is optically aligned with both the first optical component and the second optical component to convey light output from the plurality of lenses of the first optical component into the plurality of optical fibers of the second optical component.
